(19) United States
(12) Patent Application Publication
(10) Pub. No.: US 2013/0061816 A1
(43) Pub. Date: Mar. 14, 2013

(54) Leak-Proof Pet Exercise Device and Method for Making the Same

(71) Applicant: Jodi F. Aboujaoude, West Henrietta, NY (US)

(72) Inventor: Jodi F. Aboujaoude, West Henrietta, NY (US)

(21) Appl. No.: 13/230,950

(22) Filed: Sep. 13, 2011

(51) Int. Cl. A01K 15/02; B23P 11/00; A01K 29/00

(52) U.S. Cl. 119/707; 29/428

(57) ABSTRACT

A leak-proof pet exercise device and method for making the same is provided. The device comprises outer and inner shells spaced apart to form a retaining chamber therebetween. The outer shell includes external and internal surfaces including at least one first aperture defined therein. The inner shell includes external and internal surfaces including at least one second aperture defined therein. The internal surface of the inner shell defines an interior compartment for the animal. The outer shell includes a first wall extending around the periphery of the at least one first aperture and from the internal surface of the outer shell toward the external surface of the inner shell. At least a portion of the first wall is spaced a distance from the external surface of the inner shell. The inner shell does not include a wall extending around the periphery of the at least one second aperture.

### FIELD OF THE INVENTION

The present invention relates to a leak-proof pet exercise device; more particularly, the present invention is directed to an improved pet device including outer and inner shells spaced apart to define a retaining chamber therebetween to prevent liquids and solids from leaking from the outer shell. The present invention also relates to a method of forming the exercise ball using a reduced number of molds to reduce manufacturing costs.

### BACKGROUND OF THE INVENTION

Animals such as guinea pigs, mice, rats, chinchillas, ferrets, hamsters, and gerbils are typically restricted in the areas in which they can roam. For example, it is not uncommon for dogs and cats to be confined to the interior of a house, or for hamsters or gerbils to be confined to a cage. Due to the limited space available within these environments, pets normally do not get an adequate amount of exercise. Therefore, it is desirable to allow them to leave their normal surroundings for purposes of exercise and for a change in scenery.

Various devices have been developed to allow pets to exercise outside of their normal surroundings. For instance, different types of hamster wheels and pet balls have been developed to allow a pet to exercise outside of its cage. A currently existing hamster ball includes a single shell with holes defined therein to allow a hamster to breathe when positioned within the ball. This type of single shell ball allows the hamster to walk inside the ball, thus making the ball travel around the floor of a house.

While the single shell ball allows the hamster to exercise and be removed from the confines of its cage, this device suffers from a number of drawbacks and deficiencies. For instance, the holes in the ball allow the pet to breathe, but they also permit liquid and solids to leak through the holes and come into contact with the floor. The possibility that solids or liquids may leak from the ball discourages a pet owner from putting his or her pet in currently existing ball devices for long periods of time.

One device that was developed to overcome the aforementioned drawbacks of the single shell device is shown and described in U.S. Pat. No. 7,367,283 (“the '283 patent”). The device described in the '283 patent includes inner and outer shells defining a retaining chamber therebetween for retaining any liquids or solids that leak through the holes formed in the inner shell. The outer shell also includes holes that allow for air to pass into the inner shell to allow the animal to breathe. While the device in the '283 patent operates to retain liquids and solids in the retaining chamber, the manufacturing costs of this device are significant. For example, the inner shell and the outer shell are both made up of two pieces that may be joined together in order to form the inner and outer shells, respectively. Each of the pieces require a separate and distinct mold in order to form the shells because none of the pieces are identical due to, for example, the distinct attachment mechanisms defined in each of the pieces. In addition, the inclusion of an outwardly extending wall that surrounds the periphery of the holes formed in the inner shell adds to the complexity of the molds that are used to form the pieces of the inner shell, which further increases the manufacturing costs.

As such, there is a need for a leak-proof pet exercise ball that overcomes the drawbacks associated with the single shell ball, as well as a method that simplifies the manufacturing process and reduces the manufacturing cost of the dual-shell exercise device. The present invention addresses these needs as well as other needs.

### BRIEF SUMMARY OF THE INVENTION

In order to overcome the above stated problems and limitations, herein is provided an improved dual-shell pet exercise device as shown and described, and a method for making the same. The features of the device and other features of the present invention will be described in more detail below.

In one aspect, the present invention is generally directed to an exercise device for an animal including an outer shell and an inner shell. The outer shell includes an external surface and an internal surface, wherein the outer shell includes at least one first aperture defined therein. The inner shell includes an external surface and an internal surface, wherein the inner shell includes at least one second aperture defined therein that is non-coextensive with the at least one first aperture. The internal surface of the inner shell defines an interior compartment for the animal. The inner shell is configured to be positioned within the outer shell to define a retaining chamber between the external surface of the inner shell and the internal surface of the outer shell. The outer shell includes a first wall extending around the periphery of the at least one first aperture, wherein the first wall of the outer shell extends from the internal surface of the outer shell toward the external surface of the inner shell. At least a portion of the first wall is spaced a distance from the external surface of the inner shell. The inner shell does not include a wall extending around the periphery of the at least one second aperture and from the external surface of the inner shell toward the internal surface of the outer shell.

The outer shell of the device may also include a first piece and a second piece, wherein the first and second pieces are configured for being selectively coupled and decoupled with one another. The first piece of the outer shell may include a recessed portion extending inwardly from the internal surface of the outer shell. The recessed portion may include a side wall and a cap wall, wherein the side wall includes a first end and a second end, and wherein the first end of the side wall extends inwardly from the internal surface of the outer shell, and the cap wall is coupled with the second end of the side wall. The inner shell may have an access opening defined therein, wherein the cap wall is configured to cover the access opening so that the cap wall is coextensive with the inner shell. The device may also include at least one stop that extends from the side wall, which is configured to contact the inner shell adjacent to the access opening to maintain the alignment and/or spacing of the cap wall and the inner shell when the device is fully assembled. Further, at least one gripping wall may extend outwardly from the cap wall and within the recessed portion to assist a user in opening and closing the outer shell. The at least one gripping wall may also be formed in a location, other than within the recessed portion, within the external surface of the outer shell. In addition, the device may include at least one indentation defined in the second piece of the outer shell, wherein the at least one indentation is configured to be used in conjunction with the at least one gripping wall to facilitate the first and second pieces to be selectively coupled and decoupled with one another.

The device may further include an anti-rotation member extending from one of the outer shell and the inner shell, wherein the other of the outer shell and the inner shell includes an anti-rotation receiving feature configured for receiving the anti-rotation member to align the inner shell with respect to the outer shell when the inner shell is placed within the outer shell. The device may also include at least one support member extending inwardly from the internal surface of the outer shell, wherein the at least one support member is configured for being placed in contact with the external surface of the inner shell when the inner shell is positioned within the outer shell. The inner shell may include a first piece and a second piece, wherein the first and second pieces of the inner shell are configured for being selectively coupled and decoupled with one another.

In another aspect, the present invention is generally directed to a method of forming an exercise device for an animal. The method comprises the steps of providing a first mold configured for forming a first piece of an outer shell, and providing a second mold configured for forming a second piece of an outer shell, wherein the first and second pieces of the outer shell are configured to be selectively coupled and decoupled with one another. The method also comprises the step of providing a third mold configured for forming a first piece of an inner shell and a second piece of the inner shell, wherein the first and second pieces of the inner shell are configured to be selectively coupled and decoupled with one another. The method also includes the steps of forming the first piece of the outer shell using the first mold, forming the second piece of the outer shell using the second mold, forming the first piece of the inner shell using the third mold, and forming the second piece of the inner shell using the third mold. The use of a single mold to form both the pieces of the inner shell reduces the number of molds required to form the device, thereby reducing the cost of manufacturing the device. Further, the method may include the steps of coupling the first and second pieces of the inner shell together to form the inner shell, placing the inner shell inside the second piece of the outer shell, and coupling the first piece of the outer shell to the second piece of the outer shell to form the exercise device.

Additional objects, advantages and novel features of the present invention will be set forth in part in the description which follows, and will in part become apparent to those in the practice of the invention, when considered with the attached figures.

### BRIEF DESCRIPTION OF THE DRAWINGS

The accompanying drawings form a part of this specification and are to be read in conjunction therewith, wherein like reference numerals are employed to indicate like parts in the various views, and wherein:

FIG. 1 is a top front perspective view of a leak-proof pet exercise device in accordance with the present invention;

FIG. 2 is a partially exploded view of the device shown in FIG. 1 showing a first piece of an outer shell detached from a second piece of the outer shell, wherein an inner shell is positioned within the second piece of the outer shell;

FIG. 3 is a side view of the device shown in FIG. 1 with portions of the outer shell broken away;

FIG. 4 is a cross-sectional view of the device taken along line 4-4 in FIG. 3;

FIG. 4A is a cross-sectional view of one alternative embodiment of the device shown in FIG. 4;

FIG. 4B is a cross-sectional view of another alternative embodiment of the device shown in FIG. 4;

FIG. 5 is a top view of the second piece of the outer shell of the device in FIG. 1 showing the internal surface of the second piece;

FIG. 6 is a top view of the device shown in FIG. 1 showing the external surface of the top portion of the outer shell;

FIG. 7 is a bottom perspective view of the first piece of the outer shell of the device in FIG. 1 showing the internal surface of the first piece;

FIG. 8 is a top front perspective view of the inner shell shown in FIG. 2;

FIG. 9 is a bottom view of the inner shell shown in FIG. 8; and

FIG. 10 is a cross-sectional view of the device taken along line 10-10 in FIG. 3.

### DETAILED DESCRIPTION OF THE INVENTION

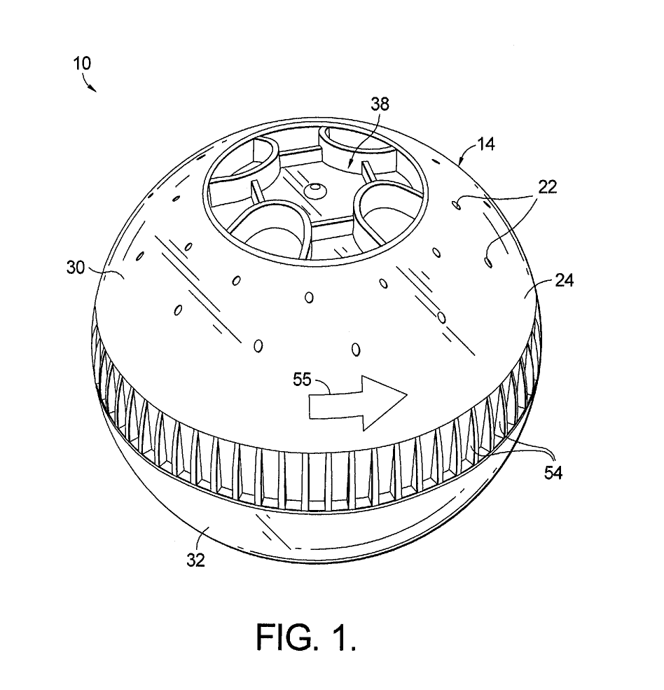

Referring now to the drawings in detail, and initially to FIGS. 1-4, reference numeral 10 generally designates a leak-proof pet exercise ball or device in accordance with the present invention. In general, device 10 may include an inner shell 12 positioned within, and spaced apart from, an outer shell 14 to form a retaining chamber 16 therebetween. Inner shell 12 defines an interior compartment 18 for placing an animal therein. One or more apertures 20 may be defined in inner shell 12 to allow liquids or solids, such as urine or feces, to pass from interior compartment 18 into retaining chamber 16 so that the liquids or solids do not collect in inner shell 12. Further, one or more apertures 22 are defined in outer shell 14 and adapted to retain the liquids and solids within the retaining chamber 16 until removed or otherwise cleaned out by a user. Therefore, device 10 allows the animal or pet to exercise by walking within interior compartment 18 so that device 10 travels around the floor, while at the same time preventing any liquids or solids that may be excreted by the animal within the confines of retaining chamber 16 from leaking out of device 10. Furthermore, device 10 also allows the animal located within interior compartment 18 to breathe, stay cool, and exercise.

As best seen in FIGS. 1-7 and 10, outer shell 14 may include an external surface 24 and an internal surface 26 having one or more apertures 22 defined therein. External surface 24 of outer shell 14 may be generally spherical to allow device 10 to roll along a surface. While external surface 24 is shown and described as being generally spherical, it will be understood that other shapes are contemplated and within the scope of the present invention. Apertures 22 may be sized and positioned in outer shell 14 so as to provide adequate air flow into and out of interior compartment 18 of device 10. For example, apertures 22 may be circular, oval, square, or rectangular-shaped.

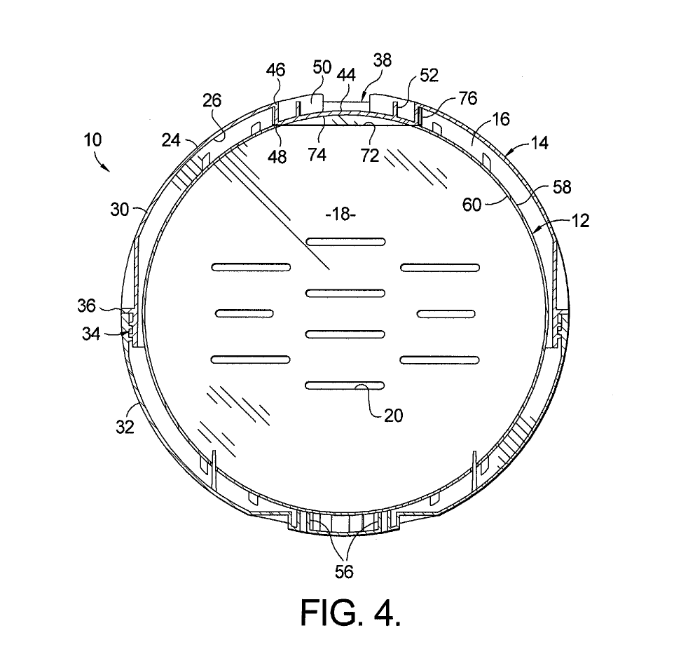

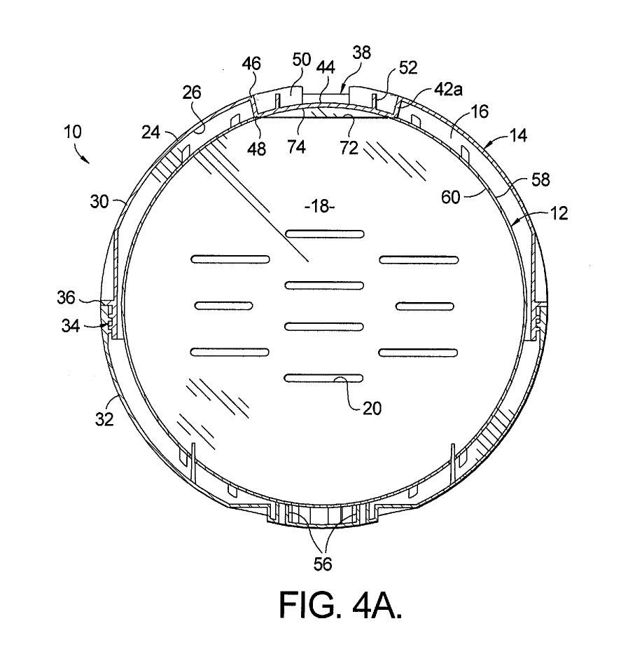

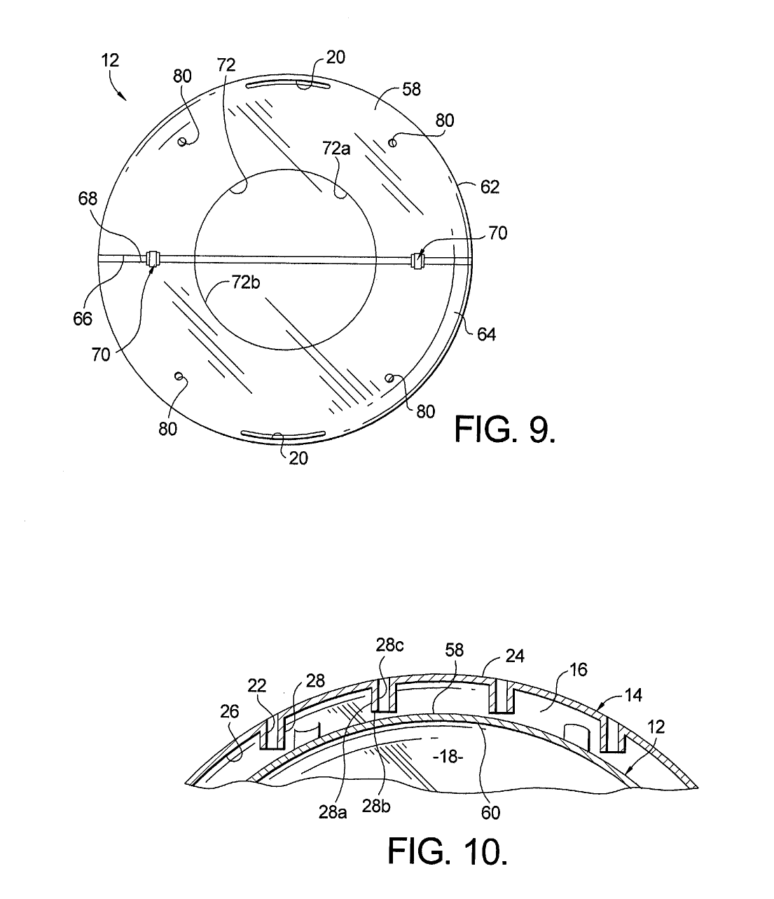

As best seen in FIG. 4, internal surface 26 of outer shell 14 may also be generally spherical so that it corresponds to the shape of its external surface 24. Outer shell 14 may be transparent, translucent or opaque. As best seen in FIGS. 5, 7 and 10, a raised edge or wall 28 is associated with each aperture 22 and extends outwardly from internal surface 26 away from external surface 24 of outer shell 14 toward inner shell 12 to retain liquids or solids disposed within retaining chamber 16. Wall 28 may extend around the periphery of each aperture 22 so that the shape of wall 28 generally matches the shape of aperture 22. For example, if aperture 22 is circular-shaped, then wall 28 would generally be circular-shaped. It should also be understood that aperture 22 and wall 28 may have shapes that do not match one another. As best seen in FIG. 10, wall 28 may include an outer surface 28a, a top surface 28b and an inner surface 28c. Wall 28 may extend outwardly from internal surface 26 so that at least a portion of top surface 28b is spaced a distance from inner shell 12 to allow air to flow from outside the device 10, into retaining chamber 16, and into interior compartment 18 to provide fresh air to the animal.

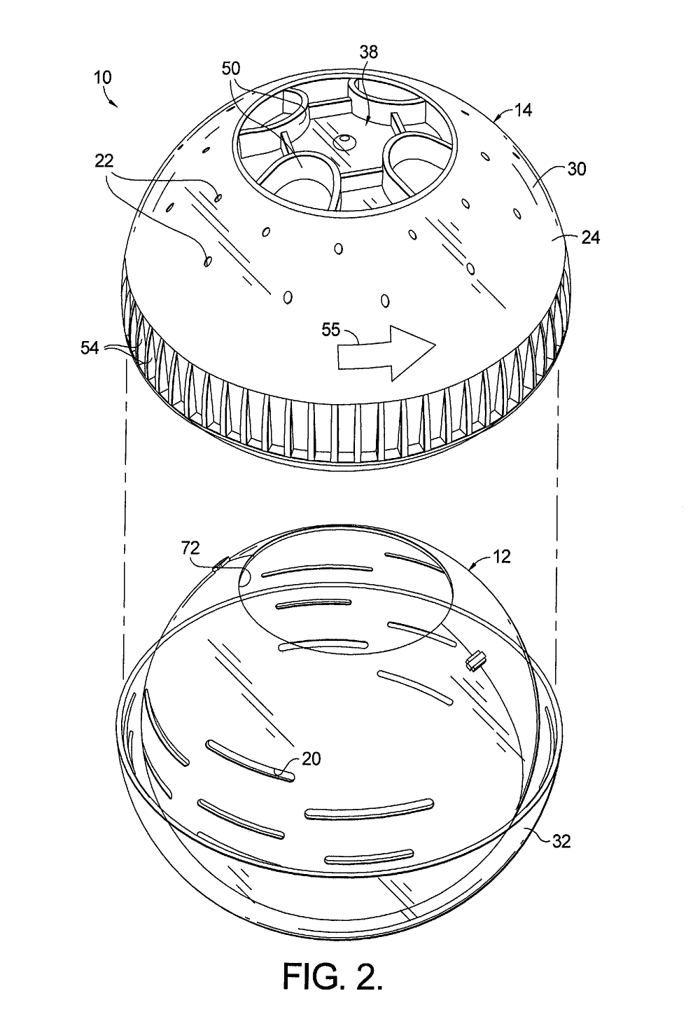

As best seen in FIGS. 2 and 4, outer shell 14 may be fabricated into first and second pieces 30, 32 configured for being selectively coupled and decoupled with one another. For example, as best seen in FIG. 4, first and second pieces 30, 32 may be coupled together by mating corresponding threads 34 formed in the rim portions of first and second pieces 30, 32. It should be understood that other connections may also be used to couple first and second pieces 30, 32 to one another, including, but not limited to, one or more snap arms formed in one of the pieces that is configured to be securely fastened within a corresponding number of snap arm openings formed in the other piece. Using either of the connection methods described above, a gasket (not shown) may be positioned at a mating surface 36 between pieces 30, 32 to prevent liquid or solid leakage through the connection point between first and second pieces 30, 32. While the present description describes the use of two pieces to form outer shell 14, it is also within the scope of the present invention to form outer shell 14 from one piece or more than two pieces.

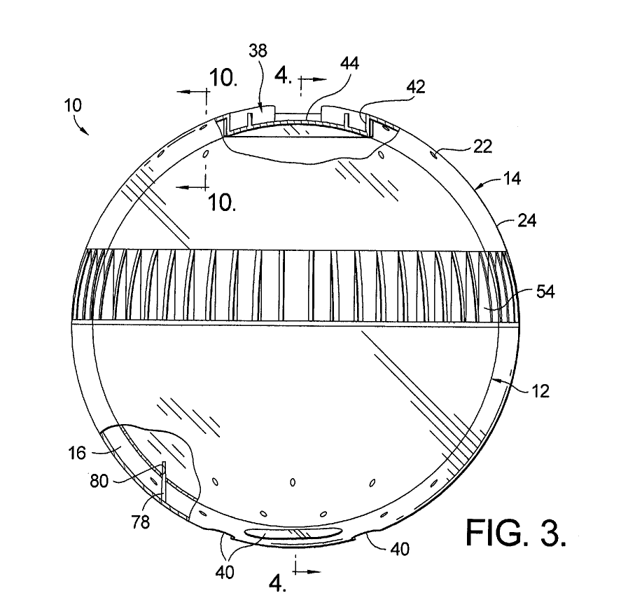

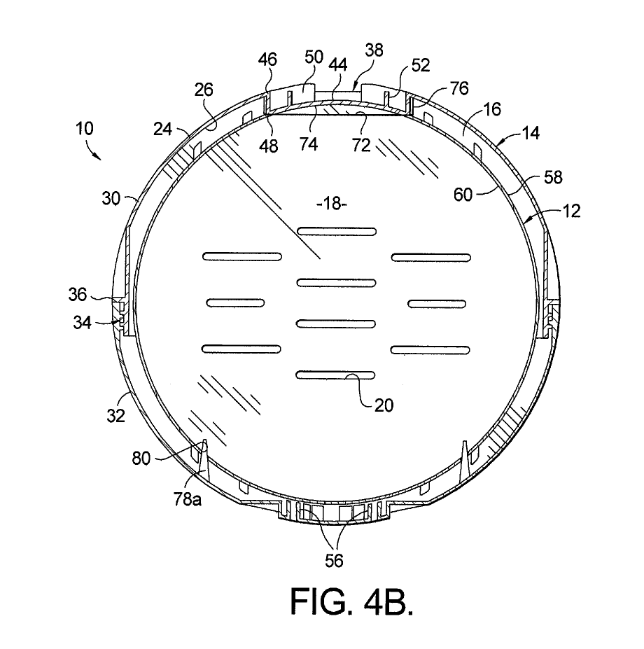

As best seen in FIGS. 1, 3 and 5-7, outer shell 14 may further include a recessed portion 38 extending inwardly from internal surface 26 of first piece 30 of outer shell 14, and at least one indentation 40 defined in second piece 32 of outer shell 14, which may be used separately or in conjunction with one another to facilitate the coupling and decoupling of first and second pieces 30, 32 from one another. In other words, a user may use recessed portion 38 and the at least one indentation 40 to better grip the two pieces 30, 32 to make it easier to twist or otherwise manipulate them to open outer shell 14. In particular, as best seen in FIGS. 4, 6 and 7, recessed portion 38 may include a side wall 42 and a cap wall 44, wherein side wall 42 includes a first end 46 and a second end 48. First end 46 of side wall 42 extends inwardly from internal surface 26 of outer shell 14, and cap wall 44 is coupled with second end 48 of side wall 42. As best seen in FIGS. 4 and 6, first piece 30 further includes at least one gripping wall 50 that extends outwardly from cap wall 44 into recessed portion 38. Gripping portions 50 may be arc-shaped and connected to side wall 42 of recessed portion 38. Further, one or more bracing members 52 extend outwardly from cap wall 44 into recessed portion 38 and between each gripping wall 50. It should be understood that gripping portions 50 may also be formed in a location, other than within recessed portion 38, within external surface 24 of outer shell 14. When decoupling first and second pieces 30, 32, a user may use at least one gripping wall 50 in conjunction with at least one indentation 40 to facilitate the opening of outer shell 14. As best seen in FIGS. 1 and 3, outer shell 14 may also include a plurality of ribs 54 defined in external surface 24 and spaced apart about the circumference of outer shell 14 to allow for additional gripping of first piece 30 of outer shell 14. An indicia 55 may be provided on external surface 24 of outer shell 14 to indicate to a user which direction the first piece 30 should be rotated relative to second piece 32 to either open or close outer shell 14.

Recessed portion 38 also may serve an additional function in that the lack of material created by recessed portion 38 may allow device 10 to rest on a display shelf or other flat surface without rolling, which eliminates the need to place device 10 in a box or other container for display purposes.

As best seen in FIGS. 4 and 5, second piece 32 of outer shell 14 may further include at least one support member 56 extending inwardly from internal surface 26 of outer shell 14. Support members 56 are configured for being placed in contact with inner shell 12 when inner shell 12 is disposed within outer shell 14 to maintain the spacing between inner shell 12 and outer shell 14.

As best seen in FIGS. 2-4, inner shell 12 is positioned within outer shell 14 and spaced apart from outer shell 14 to form retaining chamber 16. The retaining chamber 16 accepts fluid and solids originating from interior compartment 18. The distance between inner and outer shells 12, 14 provides for an adequate amount of fluid and solids to be stored therein, while allowing air to flow from outside device 10 to within interior compartment 18. The distance between inner and outer shells 12, 14 may be approximately 0.5 inches.

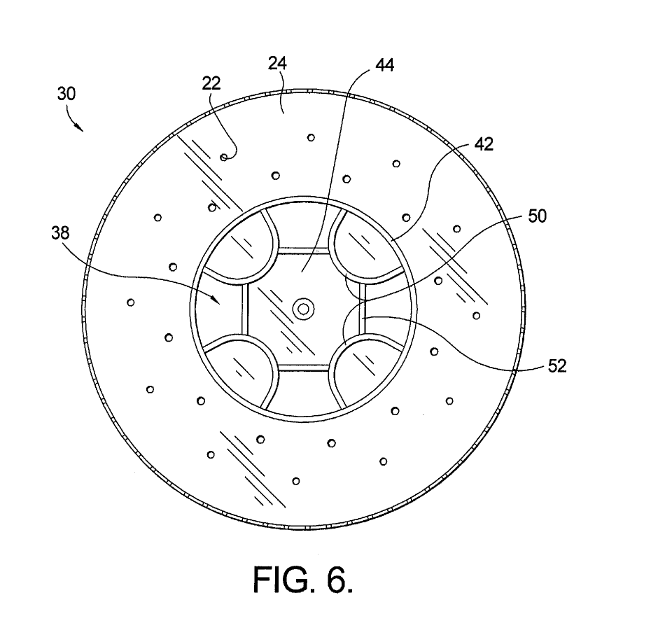

As best seen in FIGS. 4 and 10, inner shell 12 may include an external surface 58 and an internal surface 60 having one or more apertures 20 defined therein. Internal surface 60 of inner shell 12 may be generally spherical to allow liquid and solids to fall through apertures 20 and get trapped within retaining chamber 16. Further, internal surface 60 allows the animal to walk inside device 10 thereby making device 10 travel around on a surface, such as the floor of a house, while apertures 20 keep the animal clean and dry. While internal surface 60 is shown and described as being generally spherical, it will be understood that other shapes are also within the scope of the present invention. Apertures 20 may be sized and positioned in inner shell 12 so as to allow liquid and solids to pass to retaining chamber 16, provide adequate air flow into and out of interior compartment 18 of device 10, and allow the animal to run within the ball without getting its feet caught in apertures 20. For example, as best seen in FIGS. 4 and 8, apertures 20 may be generally rectangular-shaped with rounded corners and spaced apart from one another.

Moreover, the one or more apertures 20 formed in inner shell 12 are misaligned or staggered with apertures 22 defined in outer shell 14. In particular, as best seen in FIG. 2, apertures 20, 22 are misaligned or non-coextensive with each other so that liquid passing through one or more of apertures 20 in inner shell 12 does not pass directly out of a corresponding aperture 22 formed in outer shell 14. The apertures 20, 22 are misaligned or placed in an alternating arrangement so that the liquids and solids entering the retaining chamber 16 from interior compartment 18 are captured within retaining chamber 16.

With reference to FIGS. 4, 8 and 9, external surface 58 of inner shell 12 may be generally spherical so that it corresponds to the shape of internal surface 60 of inner shell 12 and internal surface 26 of outer shell 14. Inner shell 12 may be transparent, translucent, or opaque. As best seen in FIG. 8, in accordance with one aspect of the invention, external surface 58 of inner shell 12 surrounding the periphery of each of apertures 20 does not include a raised edge or wall that extends around the periphery of each aperture 20 and outwardly from external surface 58 toward internal surface 26 of outer shell 14. It has been found that any liquids or solids that pass through apertures 20 in inner shell 12 into retaining chamber 16 will generally settle in the lowest lying area of retaining chamber 16 when device 10 is at rest due to gravity, and will not pass back through apertures 20 when device 10 is in motion because centrifugal force will cause the liquids or solids to ride up the internal surface 26 of outer shell, wherein walls 28 surrounding apertures 22 prevent the liquids and solids from escaping through apertures 22 in outer shell 14. The elimination of the wall or raised edge from external surface 58 of inner shell 12 also allows for the use of a simplified mold for forming inner shell 12 during the manufacturing process, which thereby reduces the manufacturing costs for device 10.

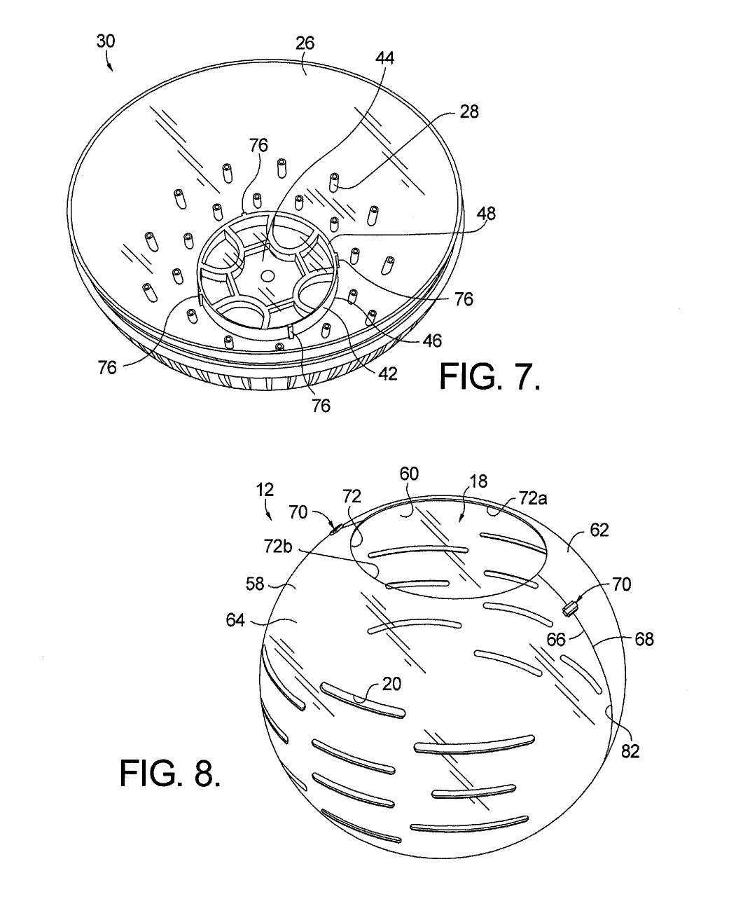

As best seen in FIGS. 8 and 9, inner shell 12 may also include first and second pieces 62, 64. First and second pieces 62, 64 may be configured to include corresponding rims 66, 68, wherein first and second pieces 62, 64 may be selectively coupled and decoupled with one another to allow for inner shell 12 to be cleaned or to allow access to interior compartment 18. For example, first and second pieces 62, 64 may include one or more fastening mechanisms 70, such as, but not limited to, a snap arm and corresponding receiving feature, which securely hold first and second pieces 62, 64 together during operation of device 10.

Inner shell 12 further includes an access opening 72 defined therein and sized to allow for an animal to be placed within or removed from interior compartment 18 when first and second pieces 62, 64 of inner shell 12 are assembled. In accordance with one aspect of the present invention, a first half 72a of the access opening 72 is defined by first piece 62 of inner shell 12, and a second half 72b of access opening 72 is defined by second piece 64 of inner shell 12. The first half 72a and second half 72b may be the same size and shape, for instance, semi-circular in shape. Forming access opening 72 with two halves 72a, 72 of the same size and shape allows a single mold to be used to form both first and second pieces 62, 64, which reduces the number of molds that are needed to form device 10, which thereby reduces manufacturing costs.

In another aspect of the present invention, as best seen in FIG. 4, the cap wall 44 formed in outer shell 14 is configured to cover access opening 72 when inner shell 12 is positioned within outer shell 14 to fully enclose an animal located within interior compartment 18 of inner shell 12. In particular, cap wall 44 is positioned such that cap wall 44 is coextensive with inner shell 12 so that there is a smooth and continuous transition from internal surface 60 of inner shell 12 and an internal surface 74 of cap wall 44. This smooth and continuous transition between internals surfaces 60, 74 will allow the animal to exercise within interior compartment 18 without any interference due to a transition between internal surfaces 60, 74. Moreover, incorporating cap wall 44 into outer shell 14 eliminates the need for an additional cover piece to cover access opening 72 in inner shell 12, which simplifies the procedure for placing an animal in interior compartment 18 and reduces the manufacturing cost of producing an additional component.

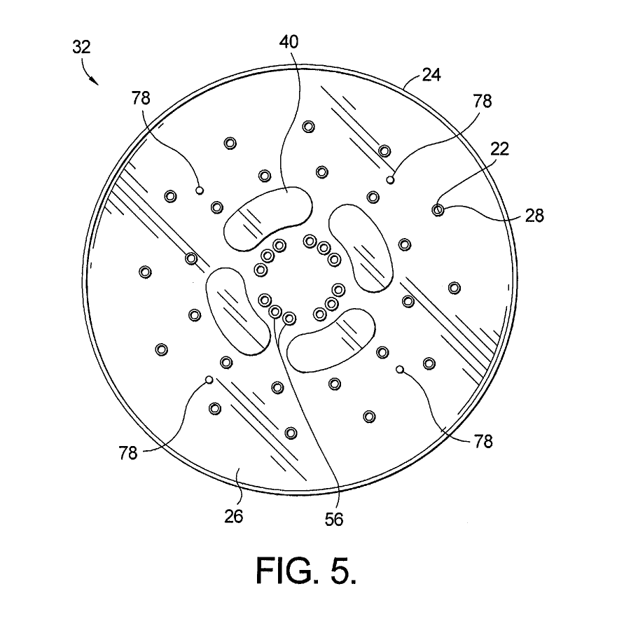

As best seen in FIGS. 4 and 7, a further aspect of the present invention includes one or more stops 76 extending from side wall 42 of recessed portion 38 of outer shell 14. Stops 76 are configured and positioned to engage inner shell 12 adjacent to access opening 72 to maintain the alignment of internal surfaces 60, 74 of cap wall 44 and inner shell 12, respectively. Without one or more stops 76, recessed portion 38 could protrude into interior compartment 18 and misalign internal surfaces 60, 74. Further, as best seen in FIG. 4A, instead of or in addition to stops 76, it is also contemplated that side wall 42a is conically shaped so that side wall 42a is tapered outwardly toward internal surface 26 whereby access opening 72 formed in inner shell 12 will not be permitted to be moved toward internal surface 26 of outer shell 14 and misalign internal surfaces 60, 74 of cap wall 44 and inner shell 12, respectively.

As best seen in FIGS. 3, 5 and 9, a further aspect of the present invention includes one or more anti-rotation members 78 extending from internal surface 26 of outer shell 14 that are configured for being received by a corresponding number of anti-rotation receiving features 80 defined in inner shell 12 when inner shell 12 is placed within outer shell 14. By including one or more anti-rotation members 78 and receiving features 80, inner shell 12 is prevented from rotating within outer shell 14 during use, thereby fixing the relationship between inner and outer shells 12, 14. For example, one type of anti-rotation member 78 may be a post that is configured for being received within a feature 80 such as a hole. However, other types of members 78 and receiving features 80 are contemplated, such as, but not limited to, a single anti-rotation member 78 that is configured for being received within a single receiving feature. It should be understood that it is also within the scope of the present invention to include one or more anti-rotation members extending from inner shell 12 and a corresponding number of anti-rotation receiving features formed in outer shell 12.

In another aspect of the present invention, as best seen in FIG. 4B, support members 56 may be spaced apart from inner shell 12 a distance, and one or more posts 78a may be conically shaped such that when inserted into receiving feature 80, the one or more posts 78a are placed in contact with the edge of receiving feature 80 to prevent inner shell 12 from being placed in contact with support members 56. As such, in this aspect of the present invention, posts 78a are used as a spacing feature to place inner shell 12 in proper spacing with outer shell 14 to maintain retaining chamber 16 and to allow air to flow into and out of support members. In another aspect of the invention, the edge of top surface 28b of one or more of walls 28 may be configured to be placed in contact with external surface 24 of inner shell 12 to provide the proper spacing between inner shell 12 and outer shell 14.

The placement of members 78 within corresponding receiving features 80 not only prevents inner shell 12 from being rotated within outer shell 14 after inner shell 12 is placed within outer shell 14, but also may provide proper positioning of inner shell 12 within outer shell 14. For instance, as best seen in FIGS. 5 and 8, the one or more members 78 and corresponding receiving features 80 may be positioned to ensure that the parting line 82 defined between first and second pieces 62, 64 of inner shell 12 are not directly located over any of supporting members 56. If parting line 82 were located over any of supporting members 56, liquids or solids may leak between first and second pieces 62, 64 and through a supporting member 56, which provides a pathway outside outer shell 14. As such, it can be seen in FIG. 5 that supporting members 56 are not formed in a complete circle, wherein certain supporting members have been eliminated to allow inner shell 12 to be oriented in ninety degree increments as determined by the placement of members 78. The lack of supporting members 56 in these areas prevents liquids or solids from leaking through parting line 82 and out of outer shell 14 through supporting members 56.

Another aspect of the present invention relates to a method of forming exercise device 10. The method generally includes providing a first mold configured for forming first piece 30 of outer shell 14, and providing a second mold configured for forming second piece 32 of outer shell 14. The method also includes providing a third mold configured for forming both first piece 62 of inner shell 12 and second piece 64 of inner shell 12. The details of inner and outer shells 12, 14 have been described in detail above and will not be repeated. The method thereafter includes the steps of forming first piece 30 of outer shell 14 using the first mold, forming second piece 32 of outer shell 14 using the second mold, forming first piece 62 of inner shell 12 using the third mold, and forming second piece 64 of inner shell 12 using the third mold. The use of a single mold (i.e., the third mold) to form both pieces 62, 64 of inner shell 12 is advantageous in that it allows for a reduction in the number of molds that are necessary to form device 10 compared to existing devices, thereby reducing the cost of manufacturing such a device 10.

After first and second pieces 62, 64 of inner shell 12 are formed using the third mold, first and second pieces 62, 64 may be coupled together using fastening mechanism 70 to form inner shell 12 shown in FIG. 8. Inner shell 12 is then placed inside second piece 32 of outer shell 14. In placing inner shell 12 within second piece 32 of outer shell 14, the one or more anti-rotation members 78 are inserted into the corresponding anti-rotation receiving features 80 and external surface 58 of inner shell 12 is placed in contact with the one or more support members 56 extending from outer shell 14. The animal may then be inserted into interior compartment 18 of inner shell 12.

First piece 30 of outer shell 14 would then be joined with second piece 32 of outer shell 14. In doing so, a user would place his or her fingers from one hand so that they are engaged with one or more of gripping walls 50 on first piece 30 of outer shell 14, and place his or her fingers on the other hand within one or more of indentations 40 in second piece 32 of outer shell 14. The user could even use one or more of ribs 54 for an additional gripping surface for first piece 30. Ribs 54 also provide rigidity to outer shell 14, which thereby reduces the amount of material that is needed to form outer shell 14. First piece 30 may then be rotated relative to second piece 32 to secure first and second pieces 30, 32 to one another using a threaded connection, for example. As first and second pieces 30, 32 are engaged with one another, cap wall 44 is positioned within access opening 72 to enclose inner shell 12 and provide a smooth surface for the animal to walk on within interior compartment 18.

Once the animal is positioned within device 10 and first and second pieces 30, 32 of outer shell 14 are coupled together, the animal may walk within interior compartment 18 to move device 10 along a surface such as a floor. The apertures 20, 22 formed in inner and outer shells 12, 14, in conjunction with retaining chamber 16 formed between inner and outer shells 12, 14, permits air to flow into interior chamber 18 thereby allowing the animal to breathe.

If the animal excretes liquids or solids, such as urine or droppings while in device 10, the liquid or solids would pass through aperture 20 formed in inner shell 12 and enter retaining chamber 16 formed between inner and outer shells 12, 14. The misalignment or staggering of the apertures 20, 22 will prevent the liquid and solids from passing out of apertures 20 and directly through apertures 22 formed in outer shell 14. Once the liquid and solids are contained within retaining chamber 16, they are prevented from escaping out of apertures 22 by raised edge or wall 28 disposed around each of apertures 22.

To remove the animal from interior compartment 18, device 10 may be opened reversing the procedure discussed above. Once device 10 is opened or disassembled, the animal may be removed so that device 10 may be cleaned by running water or another type of cleanser within retaining chamber 16, as well as within interior compartment 18.

By providing an exercise device as described herein, numerous advantages are realized. For instance, the improved exercise device described herein only requires three molds to manufacture the device, which reduces the overall manufacturing costs of the device. The device is easy to display on a shelf due to lack of material in the recessed portion. In addition, the outer shell is easy to open due to the one or more gripping walls, indentations, and/or ribs defined in the outer shell. Lastly, the number of pieces that are required to enclose an animal within the interior compartment of the device is reduced due to the cap wall formed in the outer wall that is configured to cover the access opening defined in the inner shell, which eliminates the need for a separate and distinct cap for covering the access opening that would need to be formed by an entirely separate mold.

Although the present invention has been described in considerable detail with reference to certain preferred versions thereof, other versions are possible. Therefore, the spirit and scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An exercise device for an animal, the device comprising:
an outer shell including an external surface and an internal surface, the outer shell including at least one first aperture defined therein; and
an inner shell including an external surface and an internal surface, the inner shell including at least one second aperture defined therein, the internal surface of the inner shell defining an interior compartment for the animal, wherein the inner shell is configured to be positioned within the outer shell to define a retaining chamber between the external surface of the inner shell and the internal surface of the outer shell,
wherein the outer shell includes a first wall extending around the periphery of the at least one first aperture, wherein the first wall of the outer shell extends from the internal surface of the outer shell toward the external surface of the inner shell, wherein at least a portion of the first wall is spaced a distance from the external surface of the inner shell, and wherein the inner shell does not include a wall extending around the periphery of the at least one second aperture and from the external surface of the inner shell toward the internal surface of the outer shell.

2. An exercise device in accordance with claim 1, wherein the outer shell includes a first piece and a second piece, wherein the first and second pieces are configured for being selectively coupled and decoupled with one another.

3. An exercise device in accordance with claim 2, wherein the first piece of the outer shell includes a recessed portion extending inwardly from the internal surface of the outer shell.

4. An exercise device in accordance with claim 3, wherein the recessed portion includes a side wall and a cap wall, wherein the side wall includes a first end and a second end, wherein the first end of the side wall extends inwardly from the internal surface of the outer shell, and the cap wall is coupled with the second end of the side wall.

5. An exercise device in accordance with claim 4, wherein the inner shell has an access opening defined therein, wherein the cap wall is configured to cover the access opening so that the cap wall is coextensive with the inner shell.

6. An exercise device in accordance with claim 5, further comprising at least one stop extending from the side wall, the at least one stop is configured to contact the inner shell adjacent to the access opening.

7. An exercise device in accordance with claim 5, wherein the side wall is conically-shaped, wherein the side wall is configured to contact the inner shell adjacent to the access opening.

8. An exercise device in accordance with claim 1, wherein an edge of the first wall is configured to contact the external surface of the inner shell.

9. An exercise device in accordance with claim 2, wherein the first and second pieces are threadably coupled with one another.

10. An exercise device in accordance with claim 4, further comprising at least one gripping wall extending outwardly from the cap wall and within the recessed portion.

11. An exercise device in accordance with claim 10, further including at least one indentation defined in the second piece of the outer shell, wherein the at least one indentation is configured to be used in conjunction with the at least one gripping wall to facilitate the first and second pieces to be selectively coupled and decoupled with one another.

12. An exercise device in accordance with claim 1, further comprising at least one gripping wall defined in the external surface of the outer shell.

13. An exercise device in accordance with claim 1, wherein the outer shell includes a plurality of ribs spaced apart about the circumference of the outer shell.

14. An exercise device in accordance with claim 1, wherein one of the outer shell or the inner shell includes an anti-rotation member extending therefrom, and wherein the other of the outer shell or the inner shell includes an anti-rotation receiving feature configured for receiving the anti-rotation member to align the inner shell with respect to the outer shell when the inner shell is placed within the outer shell.

15. An exercise device in accordance with claim 1, wherein one of the outer shell or the inner shell includes a conically shaped member extending therefrom, and wherein the other of the outer shell or the inner shell includes an receiving feature configured for receiving and contacting the conically shaped member for spacing the inner shell from the outer shell.

16. An exercise device in accordance with claim 1, further including at least one support member extending inwardly from the internal surface of the outer shell, wherein the at least one support member is configured for being placed in contact with the external surface of the inner shell when the inner shell is positioned within the outer shell.

17. An exercise device in accordance with claim 1, wherein the inner shell includes a first piece and a second piece, wherein the first and second pieces of the inner shell are configured for being selectively coupled and decoupled with one another.

18. An exercise device in accordance with claim 1, wherein the at least one first aperture and the at least one second aperture are non-coextensive.

19. An exercise device in accordance with claim 1, wherein at least one of the outer and inner shells are spherical.

20. An exercise device for an animal, the device comprising:
a spherical outer shell including an external surface and an internal surface, the outer shell including at least one first aperture defined therein, the outer shell including first and second pieces that are configured for being selectively coupled and decoupled with one another, the first piece of the outer shell including a recessed portion extending inwardly from the internal surface of the outer shell, the recessed portion including a side wall, a cap wall, and at least one stop extending from the side wall, the side wall including a first end and a second end, the first end of the side wall extending inwardly from the internal surface of the outer shell, and the cap wall is coupled with the second end of the side wall; and
a spherical inner shell including an external surface and an internal surface, the inner shell including at least one second aperture defined therein, the inner shell including first and second pieces that are configured for being selectively coupled and decoupled with one another, the internal surface of the inner shell defining an interior compartment for the animal, wherein the inner shell is configured to be positioned within the outer shell to define a retaining chamber between the external surface of the inner shell and the internal surface of the outer shell, the inner shell having an access opening defined therein, wherein the cap wall is configured to cover the access opening so that the cap wall is coextensive with the inner shell, wherein the at least one stop is configured to contact the inner shell adjacent to the access opening,
wherein the outer shell includes a first wall extending around the periphery of the at least one first aperture, wherein the first wall of the outer shell extends from the internal surface of the outer shell toward the external surface of the inner shell, wherein at least a portion of the first wall is spaced a distance from the external surface of the inner shell, wherein the inner shell does not include a wall extending around the periphery of the at least one second aperture from the external surface of the inner shell toward the internal surface of the outer shell, and wherein the at least one first aperture and the at least one second aperture are non-coextensive.

21. An exercise device in accordance with claim 20, wherein one of the outer shell and the inner shell includes an anti-rotation member extending therefrom, and wherein the other of the outer shell and the inner shell includes an anti-rotation receiving feature configured for receiving the anti-rotation member to align the inner shell with respect to the outer shell when the inner shell is placed within the outer shell.

22. An exercise device in accordance with claim 21, wherein at least one support member extends inwardly from the internal surface of the outer shell, and wherein the at least one support member is configured for being placed in contact with the external surface of the inner shell when the inner shell is positioned within the outer shell.

23. An exercise device in accordance with claim 22, wherein the first piece of the outer shell further comprises at least one gripping wall extending outwardly from the cap wall and within the recessed portion, and wherein the second piece of the outer shell includes at least one indentation defined therein configured to be used in conjunction with the at least one gripping wall to facilitate the selective coupling and decoupling of the first and second pieces.

24. A method of forming an exercise device for an animal, the method comprising:
providing a first mold configured for forming a first piece of an outer shell;
providing a second mold configured for forming a second piece of an outer shell, the first and second pieces of the outer shell are configured to be selectively coupled and decoupled with one another;
providing a third mold configured for forming a first piece of an inner shell and a second piece of the inner shell, the first and second pieces of the inner shell are configured to be selectively coupled and decoupled with one another;
forming the first piece of the outer shell using the first mold;
forming the second piece of the outer shell using the second mold;
forming the first piece of the inner shell using the third mold;
forming the second piece of the inner shell using the third mold;
coupling the first and second pieces of the inner shell together to form the inner shell;
placing the inner shell inside the second piece of the outer shell; and
coupling the first piece of the outer shell to the second piece of the outer shell to form the exercise device.

25. A method of forming an exercise device in accordance with claim 24, wherein the outer shell includes an external surface and an internal surface, and wherein the outer shell includes at least one first aperture defined therein,
wherein the inner shell includes an external surface and an internal surface, wherein the inner shell includes at least one second aperture defined therein, wherein the internal surface of the inner shell defines an interior compartment for the animal, wherein a retaining chamber is defined between the external surface of the inner shell and the internal surface of the outer shell,
wherein the outer shell includes a first wall extending around the periphery of the at least one first aperture, wherein the first wall of the outer shell extends from the internal surface of the outer shell toward the external surface of the inner shell, wherein at least a portion of the first wall is spaced a distance from the external surface of the inner shell, and wherein the inner shell does not include a wall extending around the periphery of the at least one second aperture from the external surface of the inner shell toward the internal surface of the outer shell.

26. A method of forming an exercise device in accordance with claim 25, wherein the first piece of the outer shell includes a recessed portion extending inwardly from the internal surface of the outer shell, wherein the recessed portion includes a side wall and a cap wall, wherein the side wall includes a first end and a second end, wherein the first end of the side wall extends inwardly from the internal surface of the outer shell, and the cap wall is coupled with the second end of the side wall, wherein the inner shell has an access opening defined therein, and wherein the cap wall is configured to cover the access opening so that the cap wall is coextensive with the inner shell.

27. A method of forming an exercise device in accordance with claim 26, wherein a first half of the access opening is defined by the first piece of the inner shell, and wherein a second half of the access opening is defined by the second piece of the inner shell.
